(19) United States
(12) Patent Application Publication
(10) Pub. No.: US 2017/0328131 A1
(43) Pub. Date: Nov. 16, 2017

(54) Hybrid Stepladder and Method

(71) Applicants: Steve Woodward, Meadville, PA (US); Joe Dangrow, Mercer, PA (US); Thomas W. Parker, Jamestown, PA (US); Robert D. Beggs, Stoneboro, PA (US); John H. Werner, Wauconda, IL (US); Micky A. O'Rahilly, Shirebrook (GB)

(72) Inventors: Steve Woodward, Meadville, PA (US); Joe Dangrow, Mercer, PA (US); Thomas W. Parker, Jamestown, PA (US); Robert D. Beggs, Stoneboro, PA (US); John H. Werner, Wauconda, IL (US); Micky A. O'Rahilly, Shirebrook (GB)

(73) Assignee: Werner Co., Greenville, PA (US)

(21) Appl. No.: 15/483,697

(22) Filed: Apr. 10, 2017

Related U.S. Application Data
(60) Provisional application No. 62/322,595, filed on Apr. 14, 2016.

(51) Int. Cl. E06C 1/393; E06C 7/16

(52) U.S. Cl. CPC E06C 1/393; E06C 7/16

(57) ABSTRACT

A hybrid stepladder having two platforms upon which a user can stand, and at least one step where a length of each platform is at least double a length of the step. A method for climbing.

### CROSS-REFERENCE TO RELATED APPLICATIONS

This is a non-provisional of U.S. provisional application Ser. No. 62/322,595 filed Apr. 14, 2016, incorporated by reference herein.

### FIELD OF THE INVENTION

The present invention is related to a hybrid stepladder which has two platforms upon which a user can stand in addition to at least one step. (As used herein, references to the “present invention” or “invention” relate to exemplary embodiments and not necessarily to every embodiment encompassed by the appended claims.) More specifically, the present invention is related to a hybrid stepladder which has two platforms upon which a user can stand in addition to at least one step where each platform has a length that is at least double the step's length.

### BACKGROUND

Hybrid stepladders have at least one platform that is much larger than a step of the stepladder. y having a large area on which the user can stand, relative to a step, it provides a greater degree of security and stability for the user, then if the user stood on a step. By being on the stepladder, above the ground, a user looks for this greater surface area in this greater degree of security and stability as the user performs work above the ground, so there is less or little concern for falling from the ladder and incurring injury. By being on the platform, the more closely simulates for the user working on the ground, where the risk of injury from falling, is no more or less than with the user typically experiences in day-to-day activities.

The platform ladder itself has features which make it more desirable. The platform ladder should be as lightweight a weight as possible to facilitate movement of the stepladder to desired locations. The platform ladder should be easy to fold up or open up, and be sturdy and rugged. It is advantageous for the platform ladder to have two platforms and still have all the aforesaid properties.

### BRIEF SUMMARY OF THE INVENTION

The present invention pertains to a hybrid step ladder upon which a user climbs. The hybrid stepladder comprises a front section having a first front rail and a second front rail in parallel and spaced relationship with the first front rail. The hybrid stepladder comprises a rear section having a first rear rail and a second rear rail in parallel and spaced relationship with the first rear rail. The hybrid stepladder comprises a first hinge and a second hinge which are pivotably connecting the first section and the rear section together so the front and rear sections can move between a closed position, where the first and second front rails of the front section are essentially in parallel with the first and second rear rails of the rear section, and an open position, where the front section and rear section form essentially an upside down V shape. The hybrid stepladder comprises a first step attached to the first and second front rails. The first step defining a first step plane. The hybrid stepladder comprises a first platform upon which the user can stand. The first platform defining a first platform plane. The hybrid stepladder comprises a second platform upon which the user can stand. The second platform defining a second platform plane. The first and second platforms each supporting at least 250 pounds of load without failing. The first and second platforms each having a width which is less than a width between the first and second front rails and the first and second rear rails, and each platform having a length that is at least double the step's length, the first and second platforms being essentially in parallel with each other and with ground when the front and rear sections are in the open position and essentially in parallel with the first and second front rails when the front and rear sections are in the closed position.

The present invention pertains to a method of a user using the hybrid stepladder as described above.

The present invention pertains to a method for a user climbing a hybrid stepladder. The method comprises the steps of the user standing on a first step of a front section of the step. There is the step of the user raising a leg while standing on the first step and placing the leg on a first platform of the stepladder which is above the first step. There is the step of the user standing on the first platform. There is the step of the user moving from the first platform to a second platform of the stepladder which is above the first platform. There is the step of the user standing on the second platform, the first and second platforms each supporting loads of at least 250 pounds without failing, each platform having a length that is at least double the step's length.

### BRIEF DESCRIPTION OF THE DRAWINGS

FIGS. 1, 2A, 2B, 3, 4A and 4B and 28 show a hybrid platform ladder with hanging brace links of the present invention.

FIGS. 5, 6, 7, 8, 9, 10, and 29 show a hybrid platform ladder with reverse fold links of the present invention.

FIGS. 11, 12, 13, 14 and 15 and 30 show a hybrid ladder with stepladder spreaders.

FIGS. 16, 17, 18, 19, 20 and 21 and 31 show a hybrid ladder with strong links.

FIGS. 22, 23, 24, 25, 26 and 27 show a hybrid platform ladder regarding a lock link.

FIGS. 32 and 33 show a perspective overhead view and a perspective underside view of a platform.

### DETAILED DESCRIPTION OF THE INVENTION

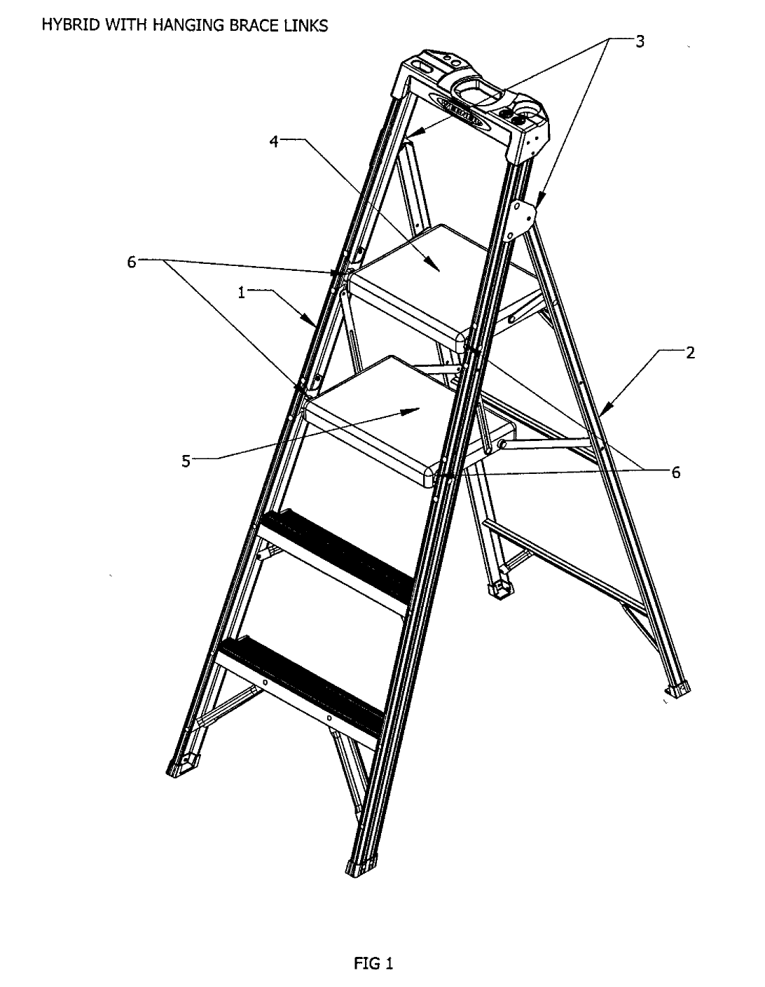

Referring now to the drawings wherein like reference numerals refer to similar or identical parts throughout the several views, and more specifically to FIGS. 1, 5, 11 and 16 thereof, there are shown four embodiments of a hybrid step ladder 100 upon which a user climbs. The hybrid stepladder 100 comprises a front section 1 having a first front rail and a second front rail in parallel and spaced relationship with the first front rail. The hybrid stepladder 100 comprises a rear section 2 having a first rear rail and a second rear rail in parallel and spaced relationship with the first rear rail. The hybrid stepladder 100 comprises a first hinge and a second hinge which are pivotably connecting the first section and the rear section 2 together so the front and rear sections 1, 2 can move between a closed position, where the first and second front rails of the front section 1 are essentially in parallel with the first and second rear rails of the rear section 2, and an open position, where the front section 1 and rear section 2 form essentially an upside down V shape. The hybrid stepladder 100 comprises a first step attached to the first and second front rails. The first step defining a first step plane. The hybrid stepladder 100 comprises a first platform upon which the user can stand. The first platform defining a first platform plane. The hybrid stepladder 100 comprises a second platform upon which the user can stand. The second platform defining a second platform plane. The first and second platforms each supporting at least 250 pounds of load without failing. The first and second platforms each having a width which is less than a width between the first and second front rails and the first and second rear rails, and each platform having a length that is at least double the step's length, the first and second platforms being essentially in parallel with each other and with ground when the front and rear sections 1, 2 are in the open position and essentially in parallel with the first and second front rails when the front and rear sections 1, 2 are in the closed position.

Referring to FIGS. 1, 2A, 2B, 3, 4A and 4B, the upper platform 4 and the lower platform 5 may be rotatably connected to the front section 1 at pivots 6. The stepladder 100 may include upper platform links 7 directly connecting the upper platform 4 to the rear section 2 and lower links 8 directly connecting the lower platform 5 to the rear section 2. The upper platform links 7 and the lower links 8 are sized and positioned so as to cause both platforms to move to a folded position when the rear section 2 is moved to its closed position. There may be a crossbar directly attached to the rear section 2 to provide a solid stop for the upper platform 4 to rest on when the ladder 100 is in the open state and ready for use. There may be hanging brace links 10 directly attached to the front section 1 at the pivots 6 and to the lower platform 5. The hanging brace links 10 have slots 12 at their lower ends where they directly connect to the lower platforms at studs 13 which are part of the lower platform 5. The hanging brace links 10 serve to support the lower platform 5 when stood upon by a user. The hanging brace links 10 may be rotatably attached to the lower platform 5 between where the lower platform 5 directly attaches to the front section 1 and the lower links 8 directly attach to the lower platform 5. The slots 12 in the hanging brace links 10 allow the studs 13 directly attached to the lower platform 5 to rise with the lower platform 5.

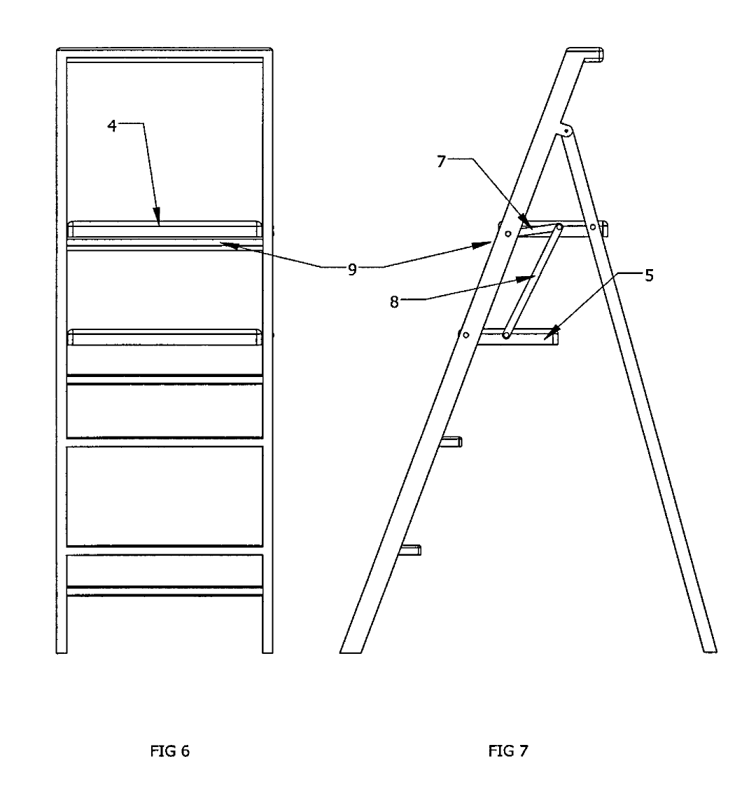

Referring to FIGS. 5-8, the stepladder 100 may include links which cause the upper and lower platforms 4, 5 to rotate in opposite directions to a folded configuration. The upper platform 4 directly connected to the rear section 2 at a first pivot 6, and the lower platform 5 is directly connected to the front section 1 at a second pivot 6, and including fixed steps 18 are rigidly attached to the front section 1. The links may include upper platform links 7 which directly connect the upper platform 4 to the front section 1; lower links 8 directly connect the lower platform 5 to the upper platform 4. The upper platform links 7 and the lower links 8 are sized and positioned so as to cause both platforms to move to a folded position when the rear section 2 is moved to the closed position. There may include a crossbar attached to the front section 1 to provide a solid stop for the upper platform 4 to rest on when the ladder 100 is open and ready for use, the lower links 8 serve to support the lower platform 5 when stood upon by a user.

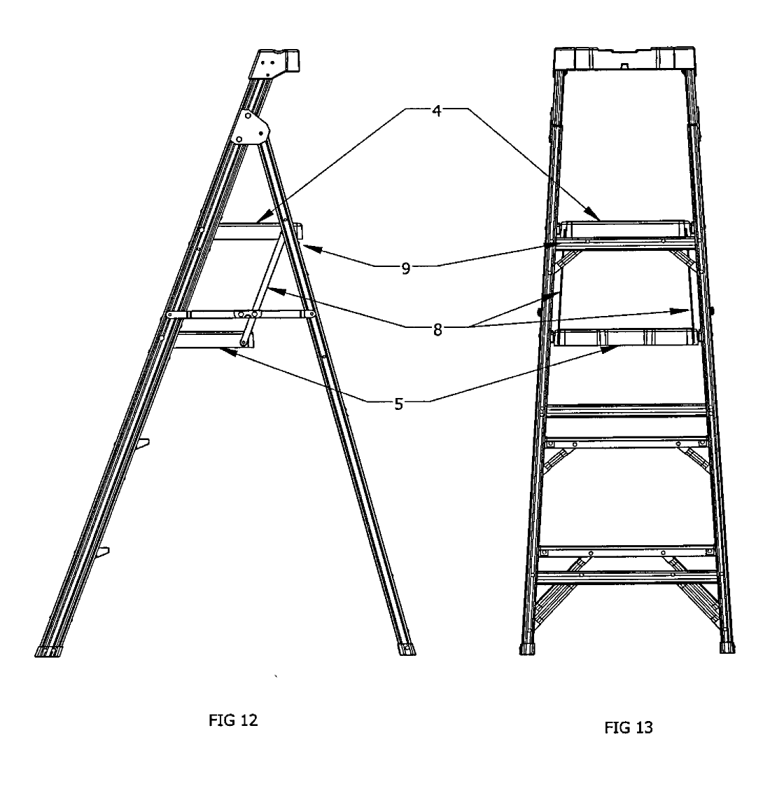

Referring to FIGS. 11 through 15, the upper platform 4 and the lower platform 5 may each directly connect to the front section 1 at pivots 6, and including spreaders 21 directly connect the front section 1 to the rear section 2 separate and apart from the upper platform 4 and the lower platform 5 and links which directly connect the upper platform 4 to the lower platform 5 in the rear section 2 to the lower platform 5 separate and apart from the spreaders 21 so that the platforms are constrained to rotate simultaneously about their pivots 6 on the front section 1. There may be a crossbar directly attached to the rear section 2 to provide a solid stop for the upper platform 4 to directly rest on when the ladder 100 is ready for use, and in the ready for use position, the lower platform 5 is supported by the links, with there being no direct connection between the upper and lower platforms 4, 5.

Referring to FIG. 16-19, the upper platform 4 and the lower platform 5 may be directly connected to the front section 1 at pivots 6, and including upper platform links 7 directly connect the upper platform 4 to the rear section 2, strong links 28 directly connect the lower platform 5 to the rear section 2. The upper platform links 7 and the strong links 28 are sized and positioned so as to cause both platforms to move to a folded position when the rear section 2 is moved to its closed position, the strong links 28 are directly connected to the lower platform 5 by pivots 6 and by hooks 29 in the strong links 28 directly engaging studs 13 attached to the lower platform 5, and a crossbar directly attached to the rear section 2 to provide a solid stop for the upper platform 4 to rest on when the ladder 100 is open and ready for use.

A user's weight on the upper platform 4 may be supported by pivots 6 through which the upper platform 4 is directly connected to the front section 1 and the crossbar, the user's weight on the lower platform 5 is supported by the pivots 6 to which the lower platform 5 is directly connected to the front section 1 and by the strong links 28. The strong links 28 have strength in tension and also in vertical bending. The bending strength of the strong links 28, combined with the direct double attachment to the lower platform 5 by the strong links 28 to a pivot 6 and a stud at a side of the lower platform 5 provides support for the lower platform 5.

Referring to FIGS. 25-27, there may be three distinct pivot points, which are at a leg section to a platform, and at a platform to a link, and at a link to a leg section, and the stepladder 100 is in an over center condition. The stepladder 100 is in the over center condition when the stepladder 100 is fully open, in which case the stepladder 100 will have no tendency to move toward the closed position if an outside force were to be applied to the stepladder 100. The over center condition maintains the stepladder 100 in the open position until the user deliberately pulls or closes the stepladder 100 by lifting up the lower platform 5. In the over center condition, the three pivot points are positioned so that one of the three pivot points is between two of the pivot points and below a straight line which connects the two pivot points.

The hybrid stepladder 100 may include a top 74 attached only to the front section 1 at a position above and in spaced relationship with the rear section 2.

The present invention pertains to a method of a user using the hybrid stepladder 100 described above.

The present invention pertains to a method for a user climbing a hybrid stepladder 100. The method comprises the steps of the user standing on a first step of a front section 1 of the step. There is the step of the user raising a leg while standing on the first step and placing the leg on a first platform of the stepladder 100 which is above the first step. There is the step of the user standing on the first platform. There is the step of the user moving from the first platform to a second platform of the stepladder 100 which is above the first platform. There is the step of the user standing on the second platform, the first and second platforms each supporting loads of at least 250 pounds without failing, each platform having a length that is at least double the step's length.

In the operation of the invention, this invention is a stepladder 100 having two fixed steps 18 of typical size for a step ladder 100, and two larger folding platforms. Larger sizes of this step ladder 100 could be produced having more than two fixed steps 18.

The two large platforms provide extra comfort and an increased sense of stability for a user who finds himself standing at or near the uppermost height of the ladder 100. Also, in contrast to a conventional step ladder 100 on which the user can stand no higher than the second step below the top 74, the Hybrid ladder 100 is designed for the user to safely stand on the platform directly below the top piece. Thus, user “reach” is maximized for a ladder 100 of a given overall height.

The Hybrid ladder 100 is designed with a capacity of at least 250 pounds (Type I). It is intended that a user weighing 250 pounds can stand on any one of the fixed steps 18 or platforms. The fixed steps 18 are approx. 17″ wide and 3.4″ from front to rear (the length). The lower platform 5 is approx. 14″ wide and 10.25″ from front to rear. The upper platform 4 is approx. 13″ wide and 10.75″ from front to rear. For the Hybrid ladder 100 with a capacity of at least 250 pounds, the following list regarding the dimensions for each embodiment described below is as follows:

HYBRID WITH HANGING BRACE LINKS
UPPER PLATFORM LINKS
3.6×0.75×0.10,
MAT'L 1010 STEEL

LOWER LINKS
9.8×0.75×0.10,
MAT'L 1010 STEEL

HANGING BRACE LINKS
11.0×0.75×0.10,
MAT'L 1010 STEEL

PLATFORMS
RIBBED CONSTRUCTION, 0.10 RIB THICKNESS
MAT'L POLYPROPYLENE

FIXED STEPS
“C” CHANNEL EXTRUSIONS, 0.10 WALL THICKNESS,
MAT'L 6061 T6 ALUMINUM

HYBRID WITH REVERSE FOLD LINKS

UPPER PLATFORM LINKS
5.10×0.75×0.10,
MAT'L 1010 STEEL

LOWER LINKS
12.5×0.75×0.10,
MAT'L 1010 STEEL

PLATFORMS
RIBBED CONSTRUCTION, 0.10 RIB THICKNESS
MAT'L POLYPROPYLENE

FIXED STEPS
“C” CHANNEL EXTRUSIONS, 0.10 WALL THICKNESS,
MAT'L 6061 T6 ALUMINUM

HYBRID WITH STEPLADDER SPREADERS

LINKS
12.00×0.75×0.10,
MAT'L 1010 STEEL

SPREADER LINKS, EACH
7.00×0.75×0.12,
MAT'L 6061 T6 ALUMINUM

PLATFORMS
RIBBED CONSTRUCTION, 0.10 RIB THICKNESS
MAT'L POLYPROPYLENE

FIXED STEPS
“C” CHANNEL EXTRUSIONS, 0.10 WALL THICKNESS,
MAT'L 6061 T6 ALUMINUM

HYBRID WITH STRONG LINKS

UPPER PLATFORM LINKS
3.60×0.75×0.10,
MAT'L 1010 STEEL

STRONG LINKS
12.5×2.00×0.125,
MAT'L 1010 STEEL

PLATFORMS
RIBBED CONSTRUCTION, 0.10 RIB THICKNESS
MAT'L POLYPROPYLENE

STUDS IN LOWER PLATFORM
MAT'L 1010 STEEL

FIXED STEPS
“C” CHANNEL EXTRUSIONS, 0.10 WALL THICKNESS,
MAT'L 6061 T6 ALUMINUM

For all the embodiments described herein, standard readily available rails, either aluminum or fiberglass having a duty 1 rating (supporting at least 250 pounds of load) are used. In addition, standard fasteners that are commonly used for step ladders having a duty—one rating, such as rivets, are used to fixedly attach the components identified herein together.

The following are descriptions of the four different embodiments of the Hybrid ladder 100.

Hybrid with Hanging Brace Links

FIG. 1 shows a perspective view of a Hybrid ladder 100 with what is called hanging brace links 10. The ladder 100 is in the full open position. The front section 1 and rear section 2 are connected to each other through hinges 3. Upper platform 4 and lower platform 5 are connected to the front section 1 at pivots 6.

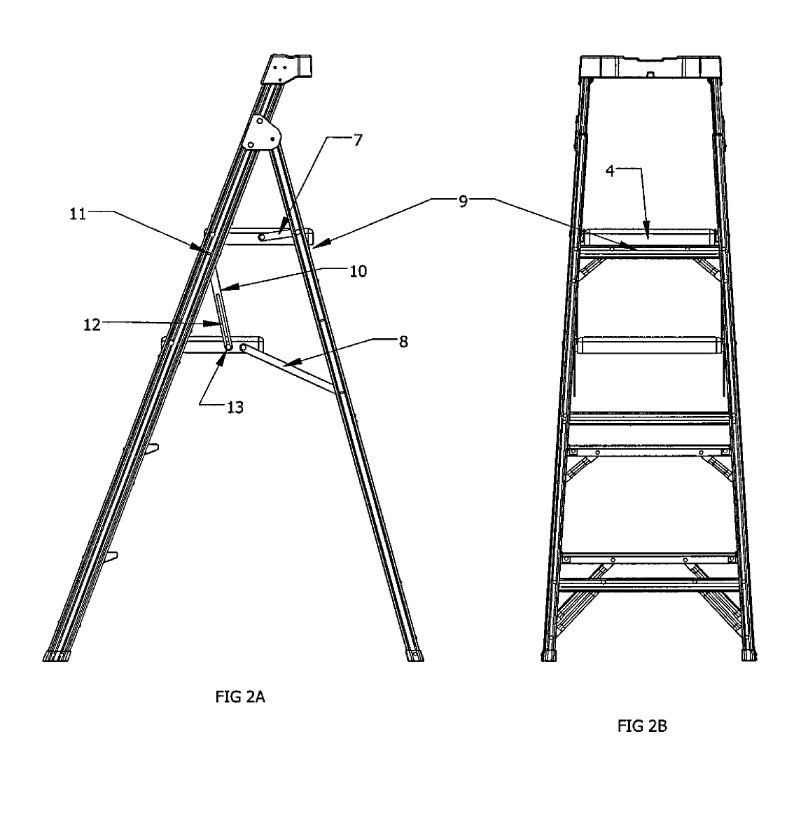

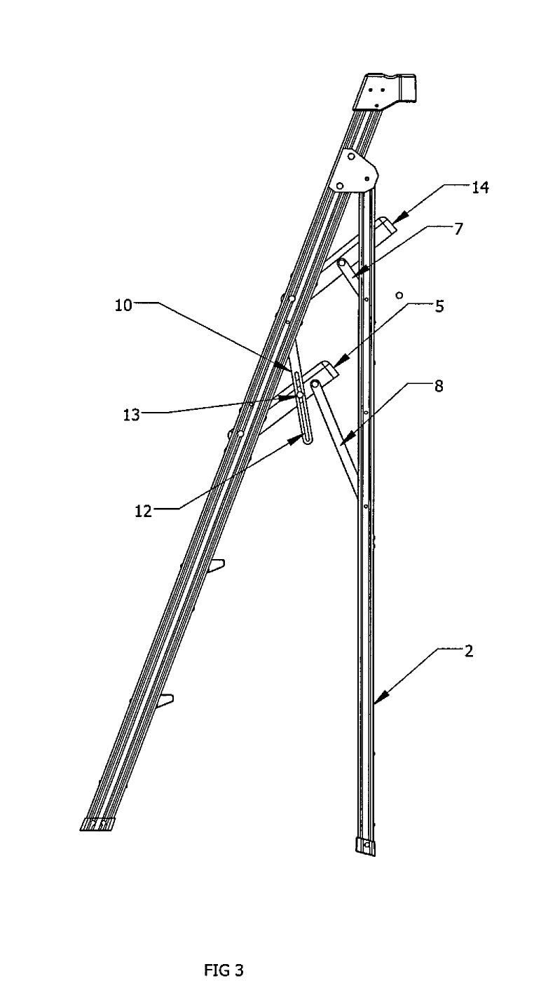

FIGS. 2a and 2b show right side and rear views of the ladder 100, respectively. Upper platform links 7 connect the upper platform 4 to the rear section 2. Lower links 8 connect the lower platform 5 to the rear section 2. These links 7 & 8 are sized and positioned so as to cause both platforms to move to a folded position when the rear section 2 is moved to its closed position. A cross bar 9 is attached to the rear section 2 to provide a solid stop for the upper platform 4 to rest on when the ladder 100 is open and ready for use. Hanging brace links 10 are attached to the front section 1 at a pivot 6 and to the lower platform 5. The hanging brace links 10 have slots 12 at their lower ends where they connect to the lower platforms at studs 13 which are part of the lower platform 5. The purpose of the slots 12 will be seen. The hanging brace links 10 serve to support the lower platform 5 when stood upon by a user.

FIG. 3 shows the ladder 100 when the rear section 2 has been partially moved toward the closed position. To close the ladder 100 the user would pull up on the rear edge 14 of the upper platform 4, causing the rear section 2 to be rotated forward because of upper platform links 7, and the lower platform 5 to rotate upward under the influence of the lower links 8. The slots 12 in the hanging brace links 10 allow the studs 13 attached to the lower platform 5 to raise with the lower platform 5.

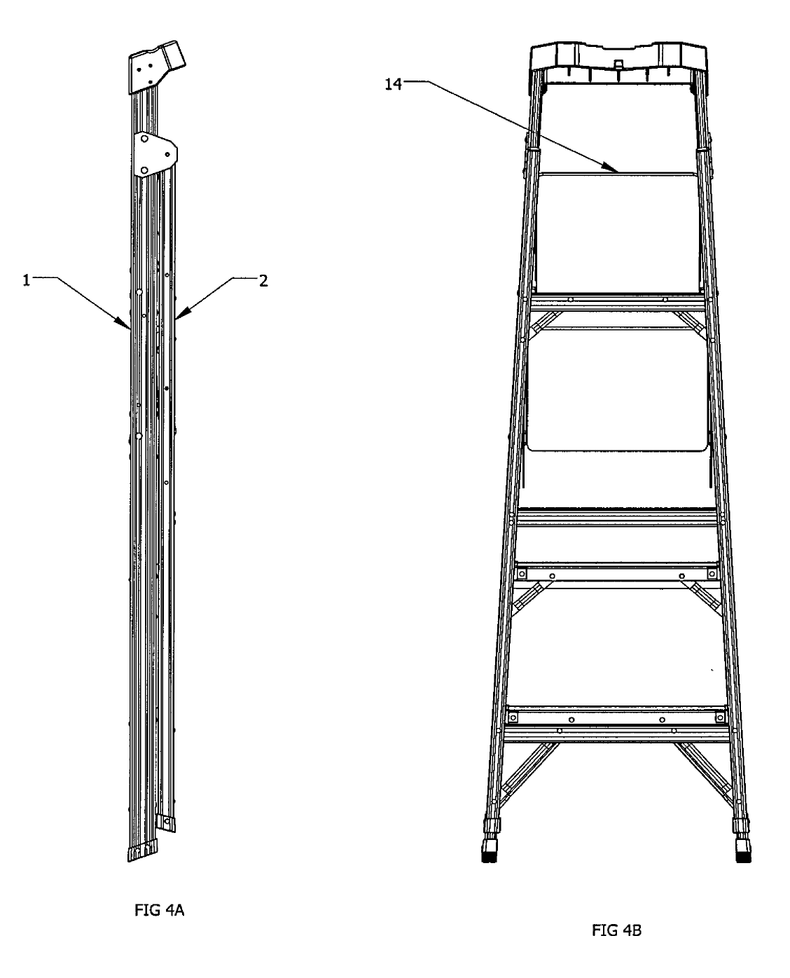

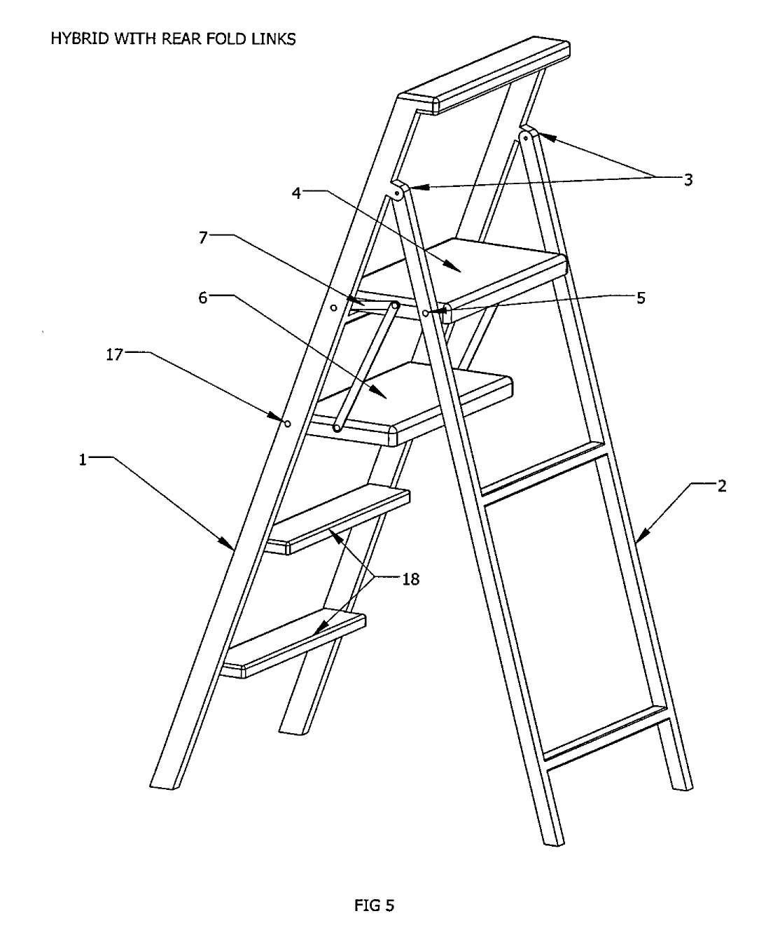

FIGS. 4a and 4b shows the ladder 100 in the fully closed position, ready for transport or stowing. The rear section 2 is parallel to the front section 1. To open the ladder 100, the user would push the rear edge 14 of the upper platform 4 rearward until the ladder 100 has assumed the position shown in FIGS. 1 & 2a & 2b.

It should be noted that no links connect the upper platform 4 to the lower platform 5.

Hybrid with Reverse Fold Links

FIG. 5 shows a perspective view of a Hybrid ladder 100 with links which cause the platforms to rotate in opposite directions to a folded configuration. The ladder 100 is shown in the full open position. The front section 1 and rear section 2 are connected to each other through hinges 3. Upper platform 4 is connected to the rear section 2 at pivot 6. Lower platform 5 is connected to the front section 1 at pivot 6. Fixed steps 18 are rigidly attached to the front section 1.

FIGS. 6 & 7 show right side and front views, respectively, of the ladder 100. Upper platform links 7 connect the upper platform 4 to the front section 1. Lower links 8 connect the lower platform 5 to the upper platform 4. These links 7 & 8 are sized and positioned so as to cause both platforms to move to a folded position when the rear section 2 is moved to its closed position. A cross bar 9 is attached to the front section 1 to provide a solid stop for the upper platform 4 to rest on when the ladder 100 is open and ready for use. The lower links 8 serve to support the lower platform 5 when stood upon by a user.

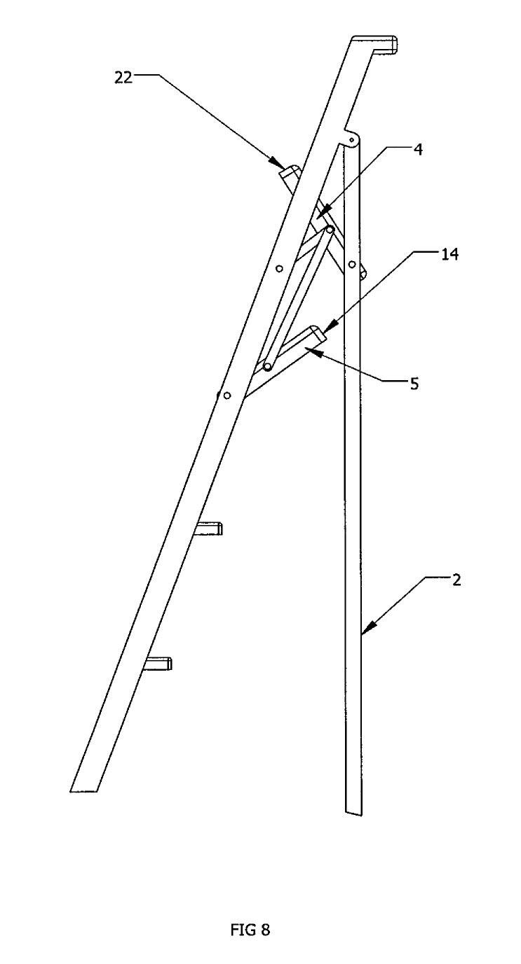

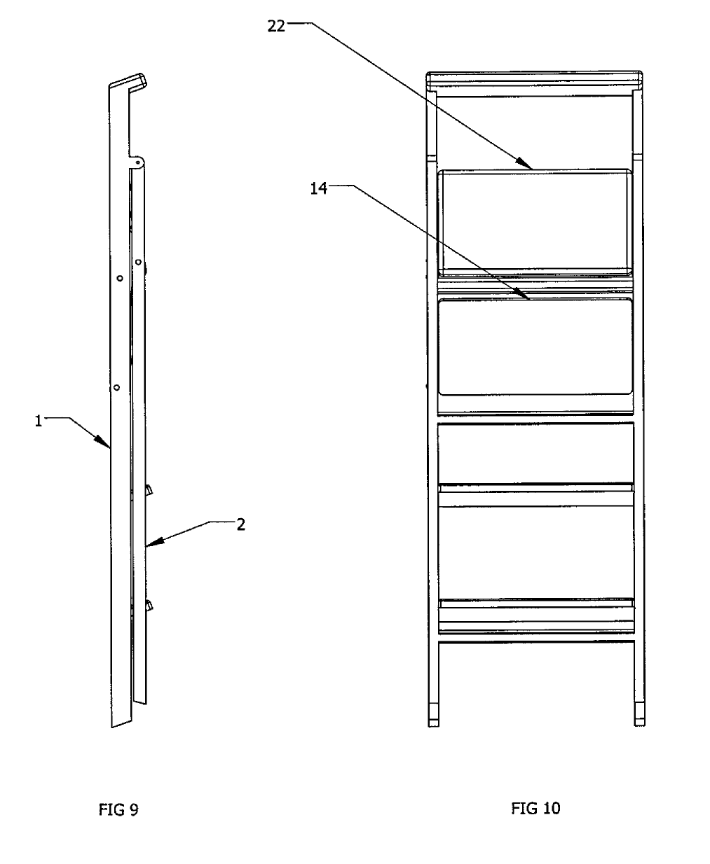

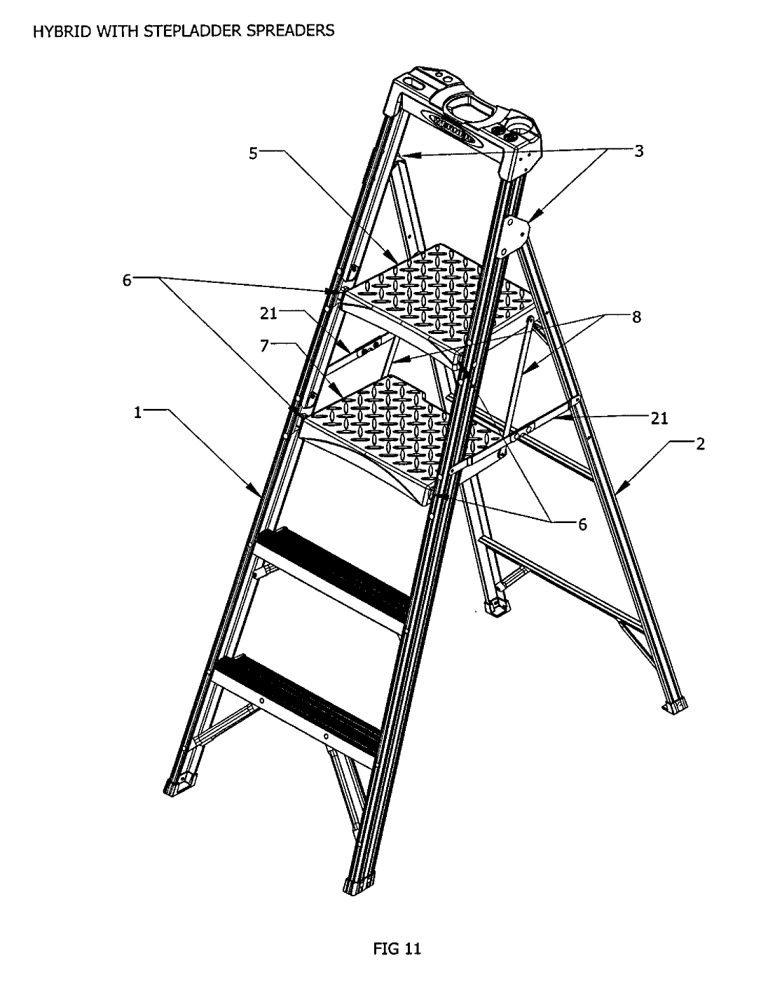

FIG. 8 shows the ladder 100 when the rear section 2 has been partially moved toward the closed position. To close the ladder 100 the user would either push up and rearward on the front edge 22 of the upper platform 4, or, pull up and forward on the rear edge 14 of the lower platform 5.

FIGS. 9 & 10 show the ladder 100 in the fully closed position, ready for transport or stowing. The rear section 2 is parallel to the front section 1. To open the ladder 100, the user would pull the front edge 22 of the upper platform 4 forward, or, push the rear edge 14 of the lower platform 5 rearward until the ladder 100 has assumed the position shown in FIGS. 5, 6 & 7.

Hybrid with Stepladder Spreaders

FIG. 11 shows a perspective view of a Hybrid ladder 100 which has stepladder 100 type spreaders 21. The ladder 100 is in the full-open position. The spreaders 21 connect the front section 1 to the rear section 2. The rear section 2 can pivot relative to the front section 1 by means of hinges 3. Links 8 connect the upper platform 4 to the lower platform 5 so that the platforms are constrained to rotate simultaneously about their pivots 6 on the front section 1.

FIGS. 12 & 13 show right side and rear views of the Hybrid ladder 100. A cross bar 9 is attached to the rear section 2 to provide a solid stop for the upper platform 4 to rest on when the ladder 100 is ready for use. In this position, the lower platform 5 is supported by the links 8.

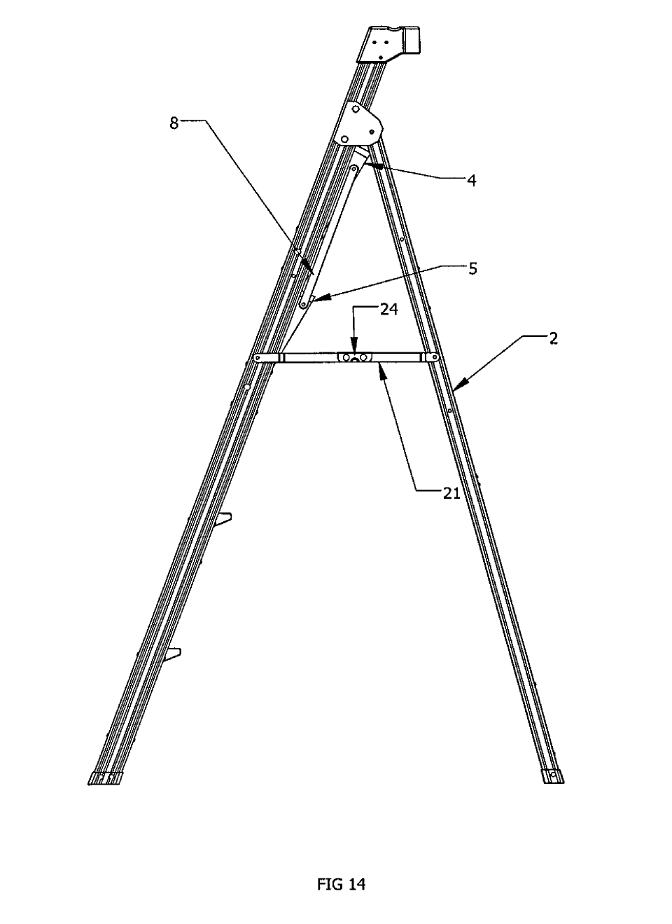

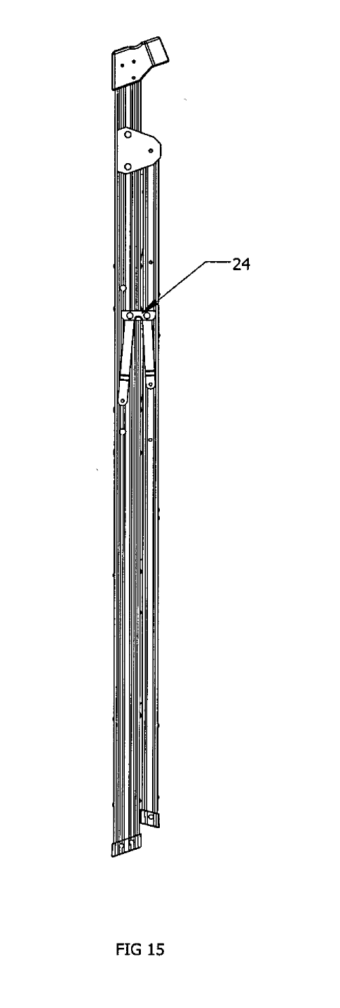

FIG. 14 shows the first step in the sequence of closing the ladder 100 for transport or stowing. The user pulls up on the rear edge 14 of either the upper platform 4 or lower platform 5 and rotates the platforms to their closed position shown. Links 8 cause the platforms to rotate together. Because there is no connection between the platforms and the rear section 2, the rear section 2 remains held open by the spreaders 21.

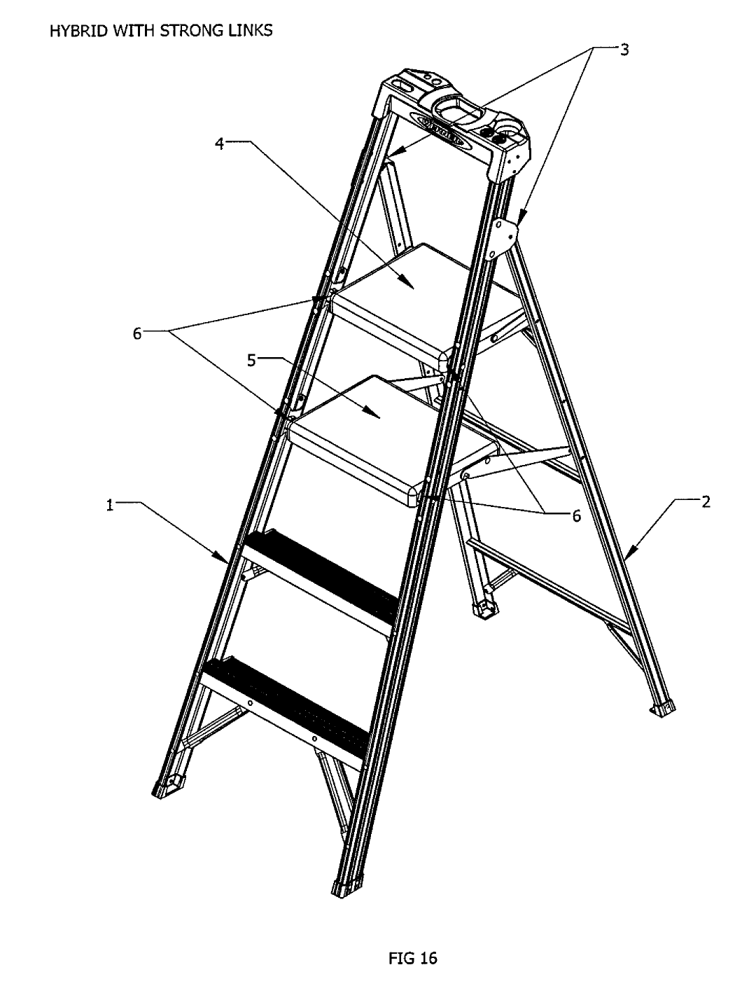

FIG. 15 shows the final step in the sequence of closing the ladder 100. The user pulls up on the center connection 24 of the spreaders 21, causing them to fold and the rear section 2 of the ladder 100 to be drawn to the closed position in the manner of a conventional stepladder 100. The ladder 100 is closed when the front section 1 and rear section 2 are parallel.

The Hybrid ladder 100 is opened for use by reversing the closing sequence: First the user straightens the spreaders 21, forcing the rear section 2 to its open position. Then the user rotates the platforms to their open position.

Hybrid with Strong Links

FIG. 16 shows a perspective view of a Hybrid ladder 100 with strong links 28. The ladder 100 is in the full open position. The front section 1 and rear section 2 are connected to each other through hinges 3. Upper platform 4 and lower platform 5 are connected to the front section 1 at pivots 6.

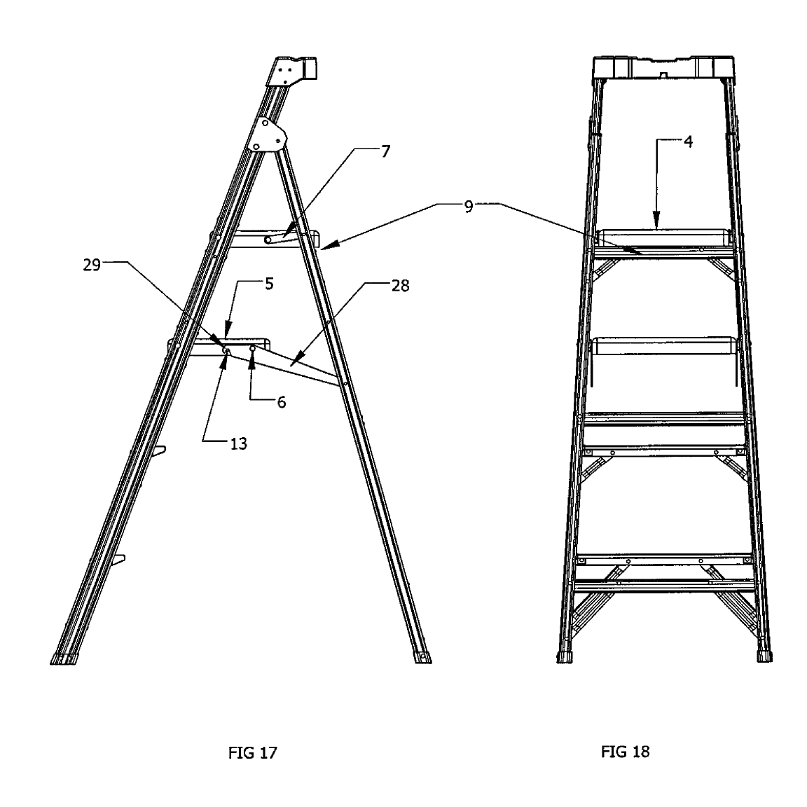

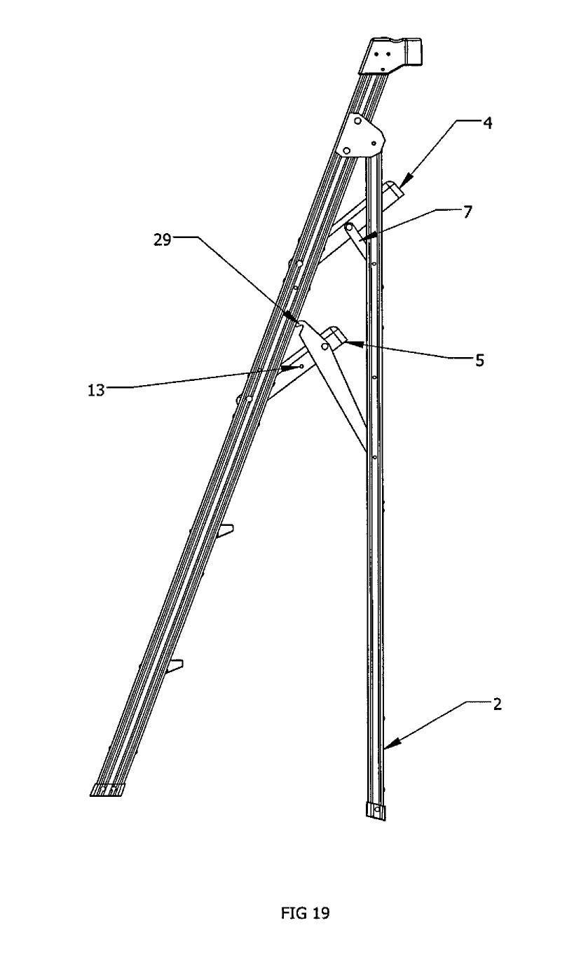

FIGS. 17 & 18 show right side and rear views of the ladder 100. Upper platform links 7 connect the upper platform 4 to the rear section 2. Strong links 28 connect the lower platform 5 to the rear section 2. These links 7 & 28 are sized and positioned so as to cause both platforms to move to a folded position when the rear section 2 is moved to its closed position. Strong links 28 are connected to the lower platform 5 by pivots 6 and by hooks 29 in the strong links 28 engaging studs 13 attached to the lower platform 5. The purpose for the hook and stud arrangement will be seen. A cross bar 9 is attached to the rear section 2 to provide a solid stop for the upper platform 4 to rest on when the ladder 100 is open and ready for use.

The weight of a user on the upper platform 4 is supported by the pivots 6 and the cross bar 9. The weight of a user on the lower platform 5 is supported by the pivots 6 and by the strong links 28. The strong links 28 are designed to have significant strength not only in tension (as are conventional links found on stepladders and stepstools) but also in vertical bending. Thus, the bending strength of the strong links 28, combined with the double attachment to the lower platform 5 by means of the pivots 6 and studs 13, serve to provide support for the lower platform 5.

FIG. 19 shows the ladder 100 when the rear section 2 has been partially moved toward the closed position. To close the ladder 100 the user would pull up on the rear edge 14 of the upper platform 4, causing the rear section 2 to be rotated forward because of upper platform links 7, and the lower platform 5 to rotate upward under the influence of the strong links 28. The hooks 29 on the strong links 28 disengage from the studs 13 on the lower platform 5, allowing the lower platform 5 to fold.

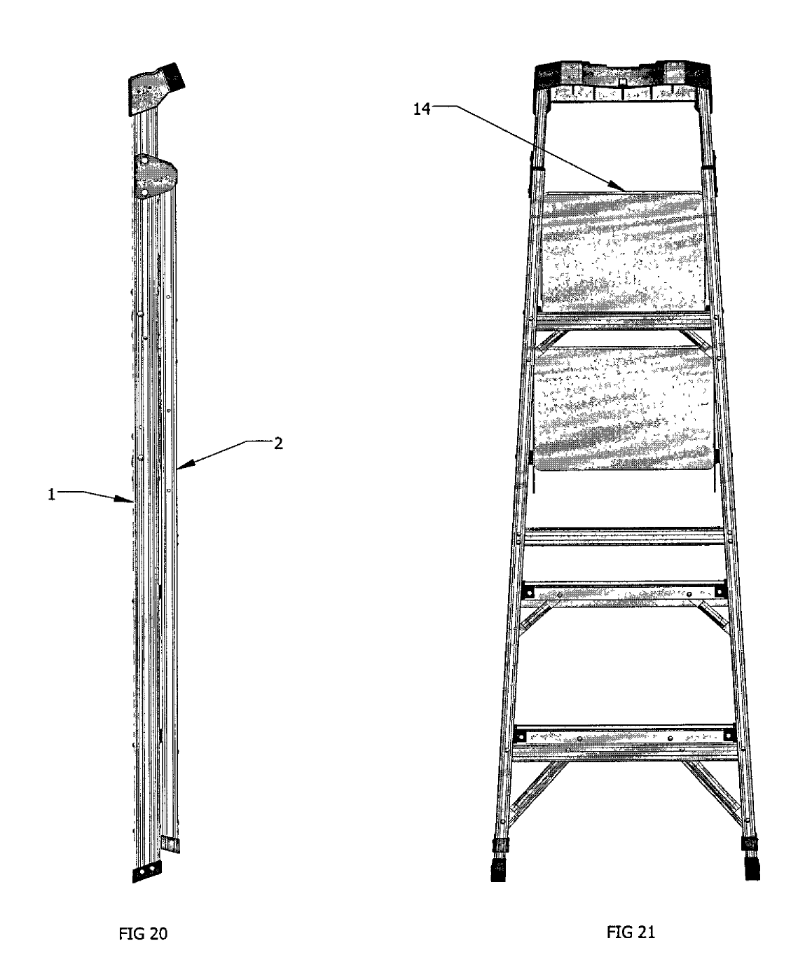

FIGS. 20 and 21 show the ladder 100 in the fully closed position, ready for transport or stowing. The rear section 2 is parallel to the front section 1. To open the ladder 100, the user would push the rear edge 14 of the upper platform 4 rearward until the ladder 100 has assumed the position shown in FIGS. 16, 17 & 18.

It should be noted that no links connect the upper platform 4 to the lower platform 5.

Description of Lock Link

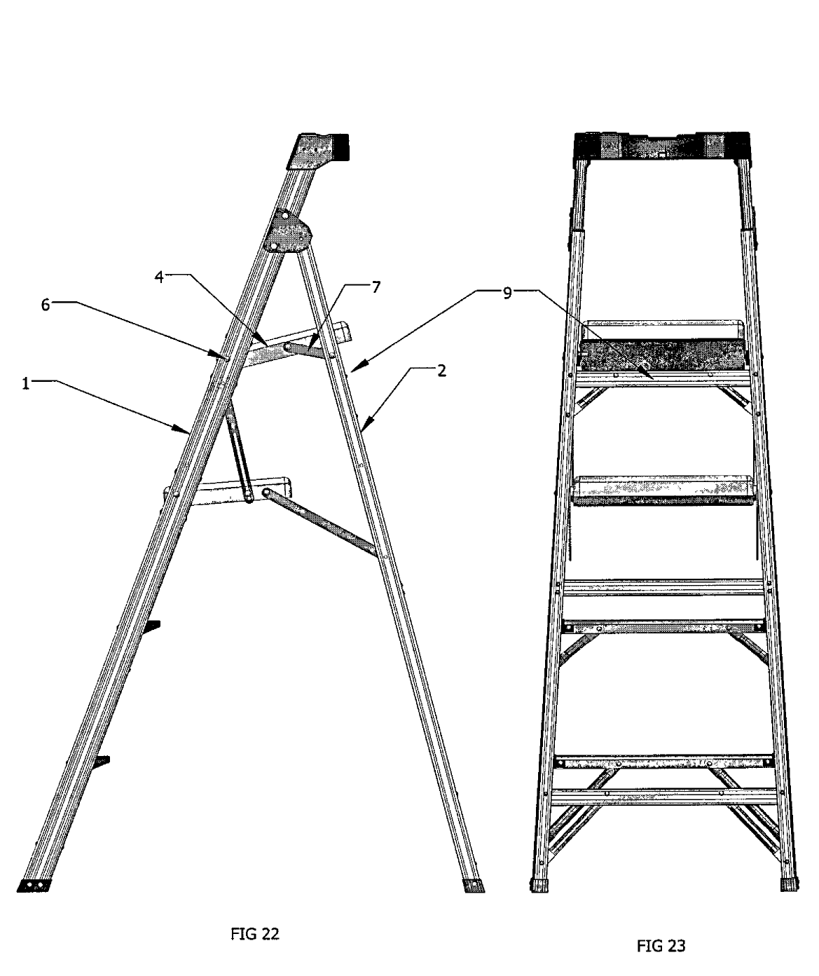

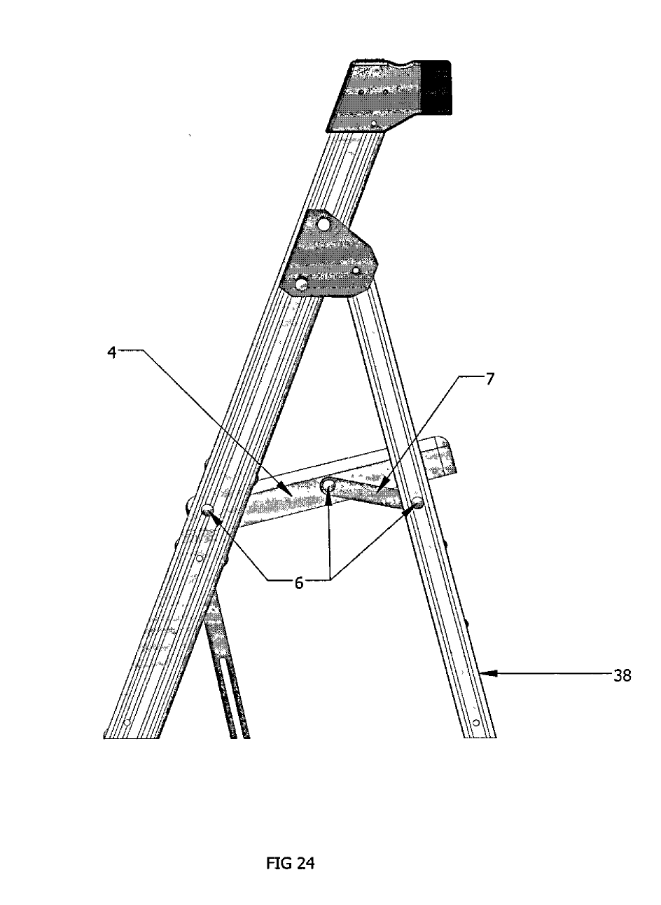

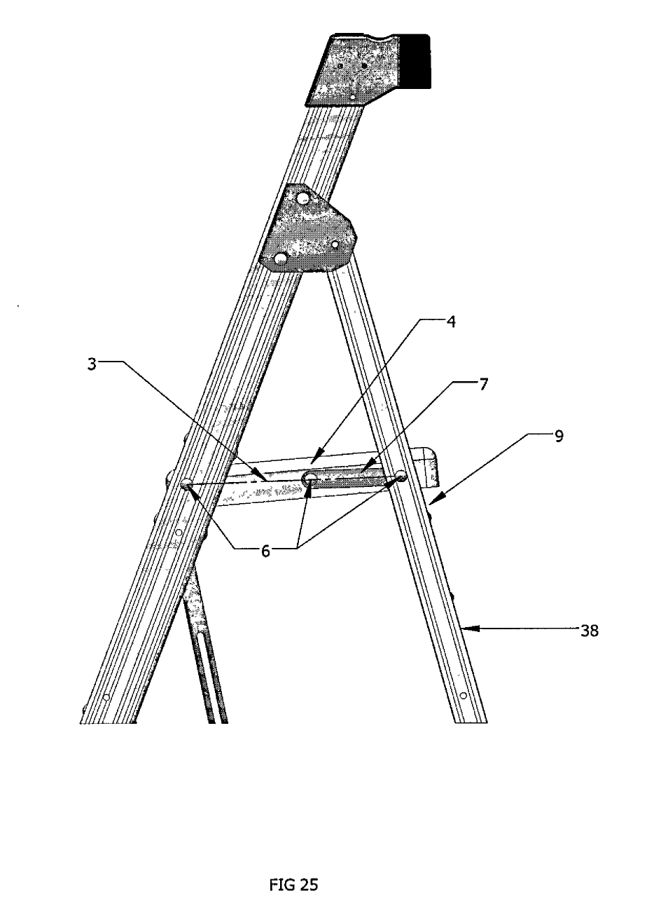

FIGS. 22 & 23 show a side view of a Hybrid type step ladder 100. The example shown is the Hanging Brace Link embodiment though the principle of the lock link being described can be applied to any Hybrid ladder 100 embodiment in which a platform is attached to the front or rear section 2 and a link connects the platform to the other section. In this case, the platform is attached to the front section 1 and a link connects the platform to the rear section 2. The purpose of this Hybrid ladder 100 feature is to insure that the ladder 100 will remain in the open position even when an external force is applied to the ladder 100.

FIGS. 22 & 23 show the ladder 100 in a position which is not quite fully open. The upper platform 4 is attached to the front section 1 at a pivot 6. A link 7 connects the platform to the rear section 2. Because the ladder 100 is not fully opened, the platform has not come to rest on the cross bar 9.

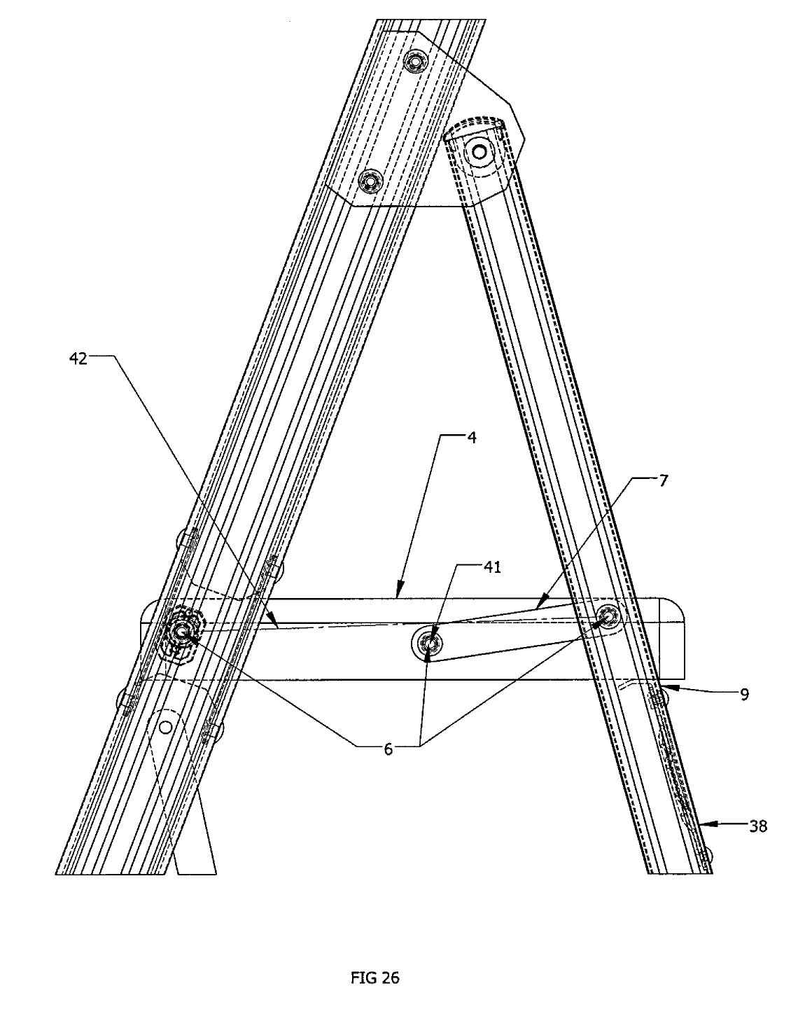

FIG. 24 is a close up view of the ladder 100, again, in the not quite fully open position. It can be understood that because of the relative position of the three pivots 6, if a force were to push forward on the rear section 2 in the direction shown by the arrow 38, the link 7 would cause the platform 4 to lift up and the ladder 100 would move toward the folded or closed position.

FIG. 25 is a close up view of the ladder 100 in a position even closer to the fully open position. The platform 4 has not yet come to rest on the cross bar 9 but the three pivots 6 are now in a straight line as indicated by the dashed line 39. It can be understood that if a force were to push forward on the rear section 2 in the direction shown by the arrow 38, because the three pivots 6 are “in line”, the link 7 would not have a tendency to force the platform toward either the fully open position or toward the folded or closed position.

FIG. 26 is a close up of the ladder 100 in the fully open position. The platform 4 is resting on the cross bar 9. The three pivots 6 are positioned so the middle pivot point 41 is below a line 42 connecting the other two. The pivots 6 are in an “over center” condition. Thus, if a force were to push forward on the rear section 2 in the direction shown by the arrow 38, the link 7 would tend to push the platform down firmly into its fully open position.

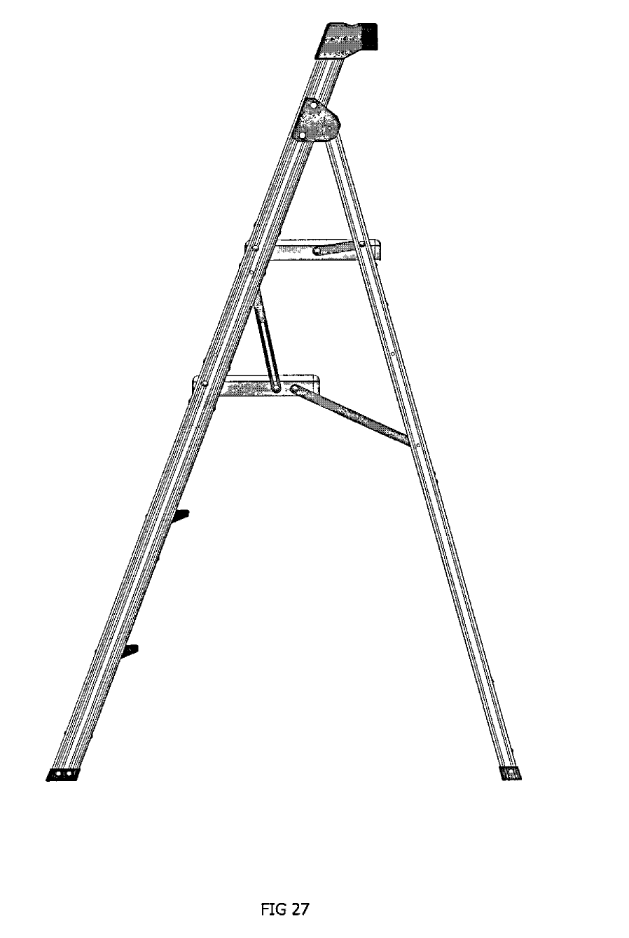

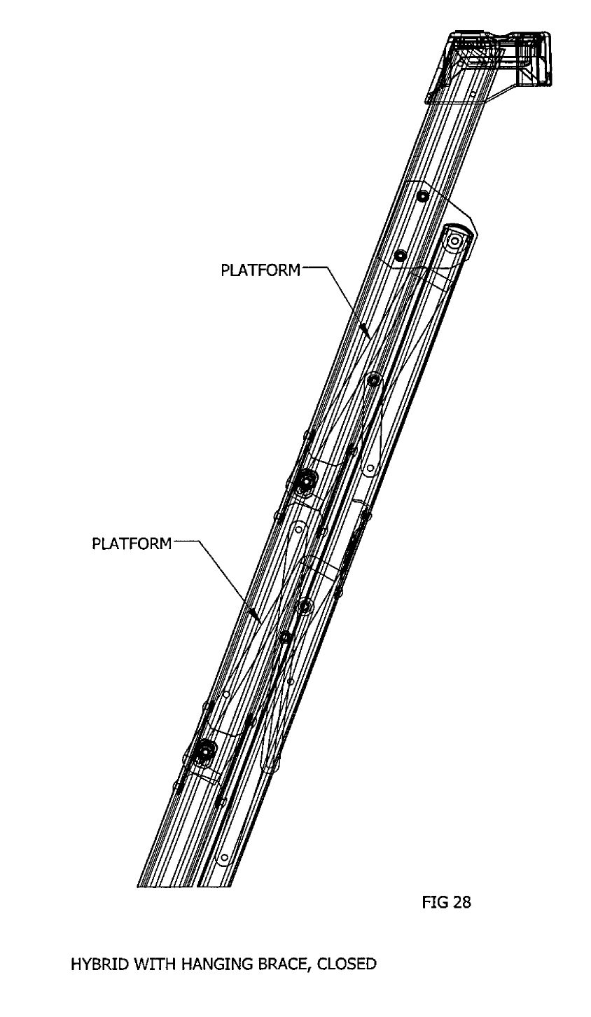

FIG. 27 shows an overall view of the ladder 100 in the fully opened position with the three pivot points in the over center condition.

If a Hybrid type step ladder 100 is designed specifically so that the three pivot points (leg section to platform, platform to link, link to leg section) are in an “over center” condition when the ladder 100 is fully open, then the ladder 100 will have no tendency to move toward the closed position if an outside force were to be applied to the ladder 100. The over center condition maintains the ladder 100 in the open position until the user deliberately folds or closes the ladder 100 by lifting up on the platform.

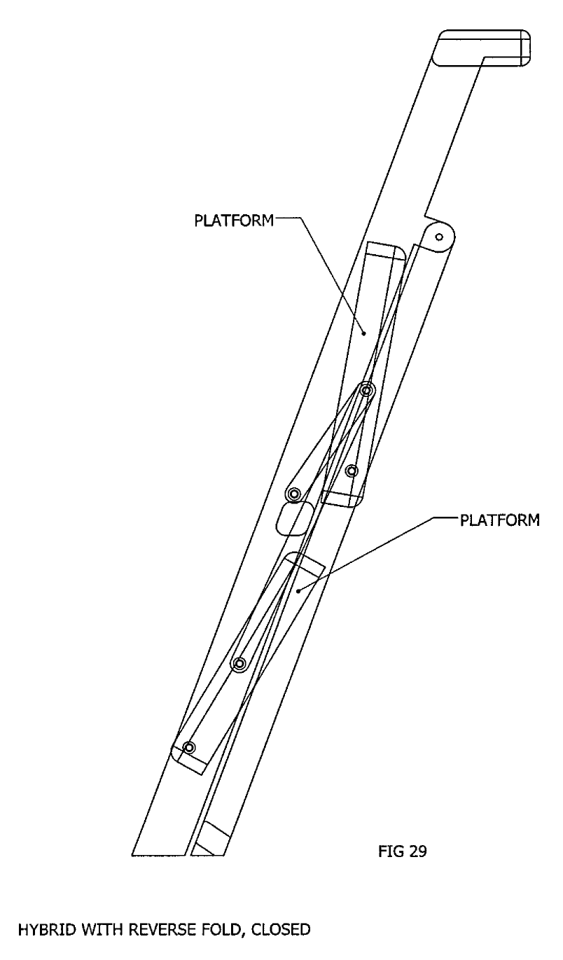

FIG. 28 shows a side view of the hybrid stepladder 100 with hanging brace links 10 in the closed position, where each platform is shown in phantom view extending beyond the width of the first front rail but not extending beyond the width of the first rear rail. In this way, the platforms stay within an envelope defined by the width of the first front rail and the second front rail for convenience of storage, without any edges or portions of either platform extending outside the envelope, where they could be damaged, or make storage more difficult while in the closed position.

FIG. 29 shows a side view of the hybrid stepladder 100 with reverse fold links in the closed position, where each platform is shown in phantom view extending beyond the width of the first front rail but not extending beyond the width of the first rear rail. In this way the platforms stay within an envelope defined by the width of the first front rail and the second front rail for convenience of storage, without any edges or portions of either platform extending outside the envelope, where they could be damaged, or make storage more difficult while in the closed position.

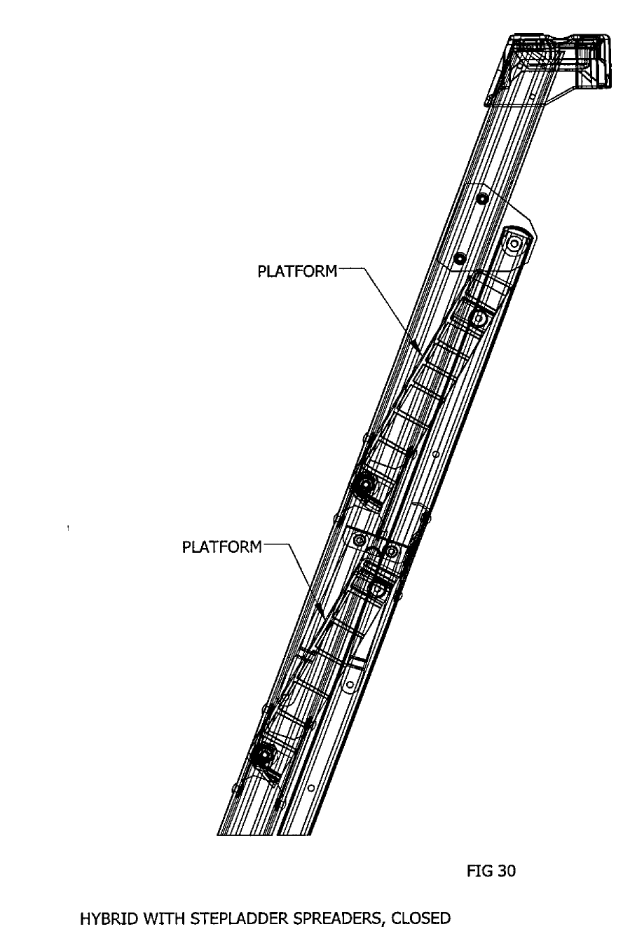

FIG. 30 shows a side view of the hybrid stepladder 100 with stepladder 100 spreaders 21 in the closed position, where each platform is shown in phantom view extending beyond the width of the first front rail but not extending beyond the width of the first rear rail. In this way the platforms stay within an envelope defined by the width of the first front rail and the second front rail for convenience of storage, without any edges or portions of either platform extending outside the envelope, where they could be damaged, or make storage more difficult while in the closed position.

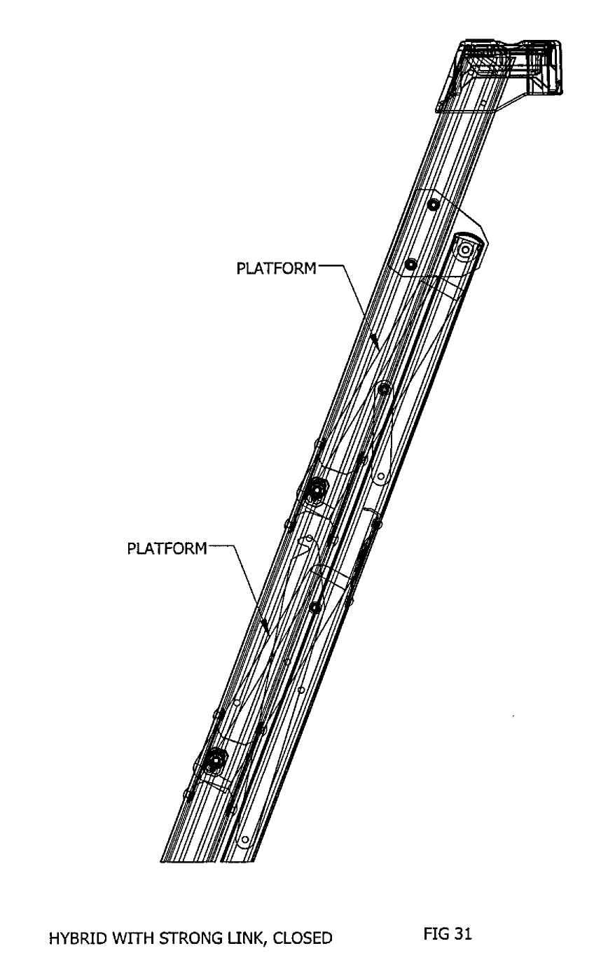

FIG. 31 shows a side view of the hybrid stepladder 100 with strong links 28 in the closed position, where each platform is shown in phantom view extending beyond the width of the first front rail but not extending beyond the width of the first rear rail. In this way the platforms stay within an envelope defined by the width of the first front rail and the second front rail for convenience of storage, without any edges or portions of either platform extending outside the envelope, where they could be damaged, or make storage more difficult while in the closed position.

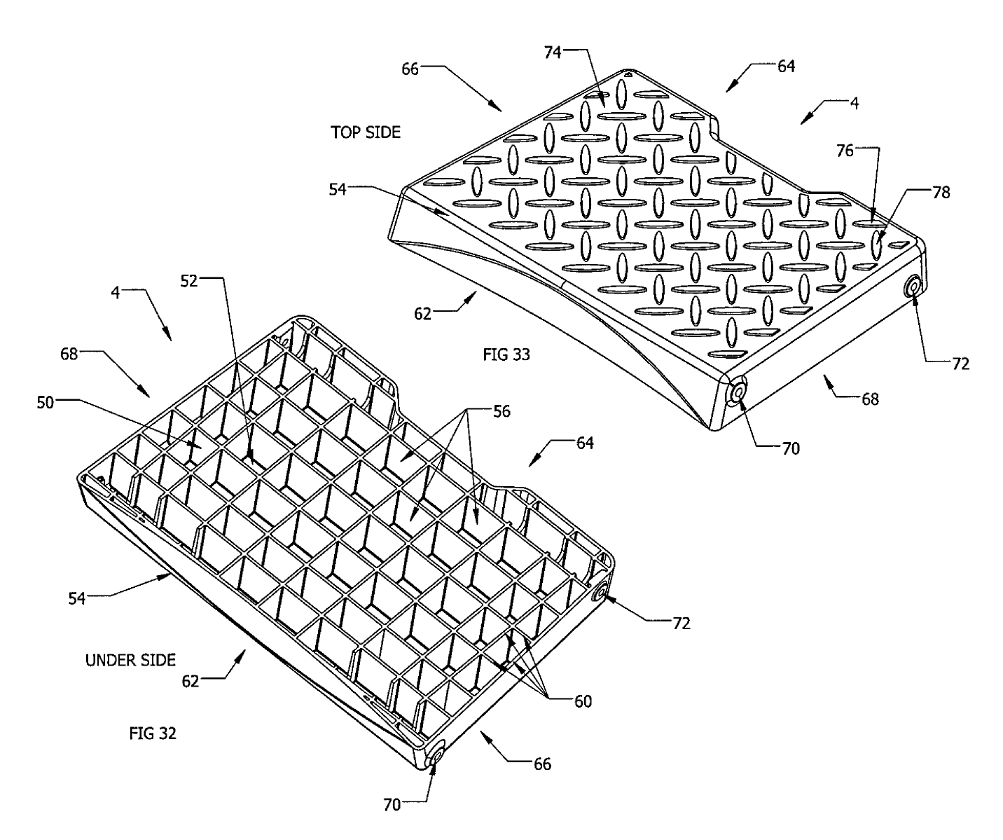

FIGS. 32 and 33 show an underside view and a topside view, respectively, of the first platform. The underside view shows the ribbing 50 to add structural support and strength to the first platform. The topside view shows elongated dimples to provide added traction for the user when the user stands on the first platform. The second platform is structurally designed in the same way. There are two holes on each side of the platform for fasteners or rods to fix the platform to the stepladder 100 as desired, for instance in a rotational relationship for the platform to pivot or rotate about between the open position and a closed position.

The ribbing 50 extends down from the bottom 52 of the surface 54 of the platform. Here, as shown in FIG. 32 the ribbing 50 forms rectangular or square cells 56, each with four walls 60 to add strength and integrity to the surface 54, without the weight of the platform being a solid slab having a thickness equal to the height of a wall of the ribbing 50. The platform has a first side 62, opposing second side 64 in spaced relation to the first side 62, a third side 66 connected to the first side 62 and second side 64, and an opposing fourth side 68 in spaced relation to the third side 66 which is connected to the first side 62 and second side 64. The first, second, third and fourth sides 62, 64, 66, 68 all extending downward from the surface 54 of the platform. As shown in FIG. 32, the third side 66 and the fourth side 68 each have a first hole 70 and a second hole 72 near each end through which fasteners, rivets or rods extend to movably attach the platform to the desired location. The ribbing 50 is disposed between the first, second, third and fourth sides 62, 64, 66, 68 of the platform.

The elongated dimples, as shown in FIG. 33 on the top 74 of the surface 54 of the platform, provide increased friction and a better grip for a user standing on the platform to not slip or fall off the platform. The dimples can form a crisscross pattern, with dimples directed in a first direction 76 being slightly thicker than the dimples directed in a second direction 78 and essentially perpendicular to the dimples in the first direction 76. The dimples in the second direction 78 are slightly longer than the dimples in the first direction 76. Each example and extends between 1/16 of an inch and ⅛ of an inch upwards from the top 74 of the surface 54 of the platform.

Although the invention has been described in detail in the foregoing embodiments for the purpose of illustration, it is to be understood that such detail is solely for that purpose and that variations can be made therein by those skilled in the art without departing from the spirit and scope of the invention except as it may be described by the following claims.

1. A hybrid a step ladder upon which a user climbs comprising:
a front section having a first front rail and a second front rail in parallel and spaced relationship with the first front rail;
a rear section having a first rear rail and a second rear rail in parallel and spaced relationship with the first rear rail;
a first hinge and a second hinge which are pivotably connecting the first section and the rear section together so the front and rear sections can move between a closed position, where the first and second front rails of the front section are essentially in parallel with the first and second rear rails of the rear section, and an open position, where the front section and rear section form essentially an upside down V shape;
a first step attached to the first and second front rails, the first step defining a first step plane;
a first platform upon which the user can stand, the first platform defining a first platform plane; and
a second platform upon which the user can stand, the second platform defining a second platform plane the first and second platforms each supporting at least 250 pounds of load without failing, the first and second platforms having a width which is less than a width between the first and second front rails and the first and second rear rails, and each platform having a length that is at least double the step's length, the first and second platforms being essentially in parallel with each other and with ground when the front and rear sections are in the open position and essentially in parallel with the first and second front rails when the front and rear sections are in the closed position.

2. The stepladder of claim 1 wherein the upper platform and the lower platform are rotatably connected to the front section at pivots.

3. The stepladder of claim 2 including upper platform links directly connecting the upper platform to the rear section and lower links directly connecting the lower platform to the rear section, the upper platform links and the lower links are sized and positioned so as to cause both platforms to move to a folded position when the rear section is moved to its closed position; a crossbar is directly attached to the rear section to provide a solid stop for the upper platform to rest on when the ladder is in the open state and ready for use; and hanging brace links are directly attached to the front section at the pivots and to the lower platform, the hanging brace links have slots at their lower ends where they directly connect to the lower platforms at studs which are part of the lower platform, the hanging brace links serve to support the lower platform when stood upon by a user.

4. The stepladder of claim 3 wherein the hanging brace links are rotatably attached to the lower platform between where the lower platform directly attaches to the front section and the lower links directly attach to the lower platform.

5. The stepladder of claim 4 wherein the slots in the hanging brace links allow the studs directly attached to the lower platform to rise with the lower platform.

6. The stepladder of claim 1 including links which cause the upper and lower platforms to rotate in opposite directions to a folded configuration, the upper platform directly connected to the rear section at a first pivot, and the lower platform is directly connected to the front section at a second pivot, and including fixed steps are rigidly attached to the front section.

7. The stepladder of claim 6 wherein the links include upper platform links which directly connect the upper platform to the front section, lower links directly connect the lower platform to the upper platform, the upper platform links and the lower links are sized and positioned so as to cause both platforms to move to a folded position when the rear section is moved to the closed position, and including a crossbar attached to the front section to provide a solid stop for the upper platform to rest on when the ladder is open and ready for use, the lower links serve to support the lower platform when stood upon by a user.

8. The stepladder of claim 1 wherein the upper platform and the lower platform are each directly connected to the front section at pivots, and including spreaders directly connect the front section to the rear section separate and apart from the upper platform and the lower platform and links which directly connect the upper platform to the lower platform in the rear section to the lower platform separate and apart from the spreaders so that the platforms are constrained to rotate simultaneously about their pivots on the front section, and a crossbar directly attached to the rear section to provide a solid stop for the upper platform to directly rest on when the ladder is ready for use, and in the ready for use position, the lower platform is supported by the links, with there being no direct connection between the upper and lower platforms.

9. The stepladder of claim 1 wherein the upper platform and the lower platform are directly connected to the front section at pivots, and including upper platform links directly connect the upper platform to the rear section, strong links directly connect the lower platform to the rear section, the upper platform links and the strong links are sized and positioned so as to cause both platforms to move to a folded position when the rear section is moved to its closed position, the strong links are directly connected to the lower platform by pivots and by hooks in the strong links directly engaging studs attached to the lower platform, and a crossbar directly attached to the rear section to provide a solid stop for the upper platform to rest on when the ladder is open and ready for use.

10. The stepladder of claim 9 wherein a user's weight on the upper platform supported by pivots through which the upper platform is directly connected to the front section and the crossbar, the user's weight on the lower platform is supported by the pivots to which the lower platform is directly connected to the front section and by the strong links, the strong links have strength in tension and also in vertical bending, the bending strength of the strong links, combined with the direct double attachment to the lower platform by the strong links to a pivot and a stud at a side of the lower platform provides support for the lower platform.

11. The stepladder of claim 1 wherein there are three distinct pivot points, which are at a leg section to a platform, and at a platform to a link, and at a link to a leg section, and the stepladder is in an over center condition when the stepladder is fully open, in which case the stepladder will have no tendency to move toward the closed position if an outside force were to be applied to the stepladder, the over center condition maintains the stepladder in the open position until the user deliberately pulls or closes the stepladder by lifting up the lower platform, in the over center condition, the three pivot points are positioned so that one of the three pivot points is between two of the pivot points and below a straight line which connects the two pivot points.

12. The hybrid stepladder of claim 1 including a top attached only to the front section at a position above and in spaced relationship with the rear section.

13. A method of a user using the hybrid stepladder of claim 1.

14. A method for a user climbing a hybrid stepladder comprising the steps of:
the user standing on a first step of a front section of the step ladder;
the user raising a leg while standing on the first step and placing the leg on a first platform of the stepladder which is above the first step;
the user standing on the first platform;
the user moving from the first platform to a second platform of the stepladder which is above the first platform; and
the user standing on the second platform, the first and second platforms each supporting loads of at least 250 pounds without failing, each platform having a length that is at least double the step's length.

15. A hybrid a step ladder upon which a user climbs comprising:
a front section having a first front rail and a second front rail in parallel and spaced relationship with the first front rail;
a rear section having a first rear rail and a second rear rail in parallel and spaced relationship with the first rear rail;
a first hinge and a second hinge which are pivotably connecting the first section and the rear section together so the front and rear sections can move between a closed position, where the first and second front rails of the front section are essentially in parallel with the first and second rear rails of the rear section, and an open position, where the front section and rear section form essentially an upside down V shape;
a first step attached to the first and second front rails, the first step defining a first step plane;
a first platform upon which the user can stand, the first platform defining a first platform plane; and
a second platform upon which the user can stand, the second platform defining a second platform plane the first and second platforms each supporting at least 250 pounds of load without failing, the first and second platforms having a width which is less than a width between the first and second front rails and the first and second rear rails, and each platform having a length that is at least double the step's length, the first and second platforms being essentially in parallel with each other and with ground when the front and rear sections are in the open position and essentially in parallel with the first and second front rails when the front and rear sections are in the closed position, each platform having a surface with elongated dimples on a top of the surface of the platform that, provide increased friction and a better grip for a user standing on the platform to not slip or fall off the platform, the dimples form a crisscross pattern, with dimples directed in a first direction being slightly thicker than the dimples directed in a second direction and essentially perpendicular to the dimples in the first direction, the dimples in the second direction are slightly longer than the dimples in the first direction, each dimple extends between 1/16 of an inch and ⅛ of an inch upwards from the top of the surface of the platform, each platform having ribbing extending downward from a bottom of the surface which forms rectangular cells having four walls.
